(19) United States
(12) Patent Application Publication
(10) Pub. No.: US 2026/0187419 A1
(43) Pub. Date: Jul. 2, 2026

(54) FPGA-BASED ACCELERATION ARCHITECTURE FOR CONVOLUTIONAL NEURAL NETWORK

(71) Applicant: Nanjing Forestry University, Nanjing City (CN)

(72) Inventors: Yanyi LIU, Nanjing City (CN); Hang DU, Nanjing City (CN); Shuo FENG, Nanjing City (CN); Mengnan JIANG, Nanjing City (CN); Changyu ZHANG, Nanjing City (CN); Xiujuan LIU, Nanjing City (CN)

(73) Assignee: Nanjing Forestry University, Nanjing City (CN)

(21) Appl. No.: 19/366,155

(22) Filed: Oct. 22, 2025

(30) Foreign Application Priority Data
Dec. 26, 2024 (CN) 202411936664.9

(51) Int. Cl. G06N 3/0464; G06N 3/063

(52) U.S. Cl. CPC G06N 3/0464; G06N 3/063

(57) ABSTRACT

Provided is a field-programmable gate array (FPGA)-based acceleration architecture for a convolutional neural network and includes: a processor system (PS), configured to: read data from an external storage device, store the data in a memory, and perform data exchange with a programmable logic (PL) through an interface module; the PL including a convolutional module, a pooling module, and an upsampling module, where the PL is configured to: receive the data from the PS through the interface module, and perform parallel computation; and the interface module, configured to: connect the PS and the PL, and separately bind logical ports of different modules in the PL to independent buses by using a latency optimization mechanism. According to the provided FPGA-based acceleration architecture for a convolutional neural network, problems such as low data transfer efficiency, high computational complexity, and inadequate inter-module coordination can be effectively resolved.

### CROSS REFERENCE TO RELATED APPLICATION

This patent application claims the benefit and priority of Chinese Patent Application No. 2024119366649, filed with the China National Intellectual Property Administration on Dec. 26, 2024, the disclosure of which is incorporated by reference herein in its entirety as part of the present application.

### TECHNICAL FIELD

The present disclosure relates to the field of deep learning hardware acceleration technologies, and in particular, relates to a field-programmable gate array (FPGA)-based acceleration architecture for a convolutional neural network.

### BACKGROUND

With rapid development of the deep learning technology, a convolutional neural network (CNN) has been extensively applied in fields such as image recognition, object detection, and semantic segmentation. However, a computational process of the CNN typically involves a large quantity of convolution, pooling, and upsampling operations, posing high requirements for computational resources and execution efficiency. A conventional processor architecture has low efficiency in handling these tasks, particularly in real-time applications requiring a low latency and a high throughput, and consequently it is difficult for the conventional processor architecture to meet performance requirements. A field-programmable gate array (FPGA), as a type of programmable hardware, has emerged as a pivotal solution for accelerating the CNN due to its parallel processing capabilities and highly efficient resource utilization. However, an existing FPGA-based acceleration architecture usually has shortcomings in data transfer efficiency, optimization of computational complexity, and inter-module coordination, failing to fully achieve system performance.

### SUMMARY

An objective of the present disclosure is to overcome disadvantages in the conventional technology by providing a field-programmable gate array (FPGA)-based acceleration architecture for a convolutional neural network, to fully leverage a hardware acceleration capability of a FPGA while maintaining high accuracy of the convolutional neural network, thereby substantially enhancing operational efficiency and significantly improving utilization of system resources.

In order to achieve the above objective, the present disclosure adopts the following technical solutions:

The present disclosure provides a FPGA-based acceleration architecture for a convolutional neural network, including:
a processor system (PS), configured to: read data from an external storage device, store the data in a memory, and perform data exchange with a programmable logic (PL) through an interface module, where a computational process is controlled and coordinated by the PS, and feature map data, weight data, and a computation result are transferred between the PS and the PL through the interface module;
the PL including a convolutional module, a pooling module, and an upsampling module, where the PL is configured to: receive the data stored in the memory from the PS through the interface module, and perform parallel computation, where
the convolutional module is configured to: extract an image feature, and optimize and reduce computational complexity by integrating a convolutional layer and a batch normalization (BN) layer into a single convolutional computational unit and adopting a Winograd convolution algorithm for optimization; the pooling module is configured to perform a pooling operation; and the upsampling module is configured to perform an upsampling operation; and
the interface module configured to: connect the PS and the PL, to support data transfer and control, and enable control instructions from the PS to be executed in coordination with the parallel computation on the PL; and separately bind logical ports of the different modules in the PL to independent buses by using a latency optimization mechanism, to support both parallel interaction and independent operation among the different modules in the PL.

Further, the interface module includes an AXI-Lite interface and an AXI-Full interface, the AXI-Lite interface is configured to transfer a control signal between the PS and the PL, and the AXI-Full interface is configured to transfer the feature map data, the weight data, and the computation result between the PS and the PL, to separate the control signal from a data stream.

Further, the interface module is configured with an expected AXI interface latency, to allow a bus request to be initiated before a read/write operation is executed.

Further, the interface module is configured to separately bind the logical ports of the different modules in the PL to independent AXI buses in a port binding manner, to support parallel data transfer among the different modules.

Further, the interface module is configured to bind the logical ports of the different modules in the PL to a same physical AXI in a bus binding manner.

Further, continuous access to data at contiguous addresses is supported by the interface module, and when a port read operation is executed, the feature map data and the weight data are transferred in a burst transfer mode, and a maximum burst length is set.

Further, the integrating a convolutional layer and a BN layer into a single convolutional computational unit includes:
obtaining a parameter of the convolutional layer, where the parameter includes a convolutional weight W and a convolutional bias b of the convolutional layer;
obtaining a parameter of the BN layer, where the parameter includes a scaling parameter γ, a bias parameter β, a mean μ, and a variance σ²;
applying the scaling parameter γ and the variance σ² of the BN layer to the convolutional weight W, and obtaining a fused convolutional weight W′ by using the following formula:

$${W}^{′} = \frac{γ}{\sqrt{{σ}^{2} + ε}} \times W ;$$

obtaining a new bias b′ by substituting the bias parameter β, and the mean μ of the BN layer, and the conventional bias b into the following formula:

$${b}^{′} = \frac{γ}{\sqrt{{σ}^{2} + ε}} \times ( b - μ ) + β ,$$

where
ε is a constant, and is used to prevent a zero denominator; and
updating the parameter of the convolutional layer to W′ and b′.

Further, the convolutional module is configured to reduce, based on the Winograd convolution algorithm, a quantity of multiplication operations required for a convolutional operation by transforming convolutional computation into a matrix multiplication.

Compared with the conventional technology, the present disclosure has the following beneficial effects.

1. The interface module is designed, to achieve efficient data exchange between the PS and the PL. The interface module is configured to separately bind the logical ports of the different modules in the PL to the independent buses by using the latency optimization mechanism, to support both parallel interaction and independent operation among the different modules in the PL. In addition, high-speed data transfer and operation scheduling can be simultaneously completed by the interface module by separating the control signal from the data stream, thereby enhancing bus resource utilization.

In the PL, the convolutional module, the pooling module, and the upsampling module are independently operated through the interface module. The data transfer and computation of each module are mutually independent, avoiding a data access conflict between the modules and achieving parallel computation. This enhances the execution efficiency and response speed of the entire system. The PS is responsible for management and task scheduling of data, and the PL is responsible for performing a computational task. The control instructions and the computation task are ensured to be synchronous through the coordinated work of the PS and the PL, and therefore, the execution efficiency and response speed of the entire system are improved.

2. The convolutional module is configured to integrate the convolutional layer and the BN layer into the single convolutional computational unit, reducing intermediate computational steps and data access times. The convolutional computation is transformed, based on the Winograd convolution algorithm, into the matrix multiplication format, remarkably reducing a quantity of multiplication operations and accelerating the convolutional operation.

A scalable and modular design that allows for flexible allocation of FPGA resources and adjustment of module functions based on specific application requirements is adopted in the present disclosure. This architecture is suitable for edge computing in small-scale embedded systems while also capable of supporting the acceleration demands of large-scale computational tasks.

### BRIEF DESCRIPTION OF THE DRAWINGS

FIG. 1 is a schematic diagram of a field-programmable gate array (FPGA)-based acceleration architecture for a convolutional neural network according to Embodiment 1 of the present disclosure.

### REFERENCE NUMERALS

1—DDR3, 2—DMA, 3—SD, 4—CPU, 5—AXI4 Lite, 6—AXI4 Full, 7—INBUFF, 8—Standard convolution, 9—Partial convolution, 10—Pooling, 11—Upsampling, 12—OUTBUFF, and 13—Control signals.

### DETAILED DESCRIPTION OF THE EMBODIMENTS

The technical solutions in the present disclosure are described in detail with reference to the accompanying drawings and specific embodiments. It should be understood that the embodiments in the present disclosure and specific features in the embodiments are detailed descriptions of the technical solutions in the present disclosure, and are not intended to limit the technical solutions in the present disclosure. The embodiments in the present disclosure and technical features in the embodiments may be combined with each other in a non-conflicting situation.

### Embodiment 1

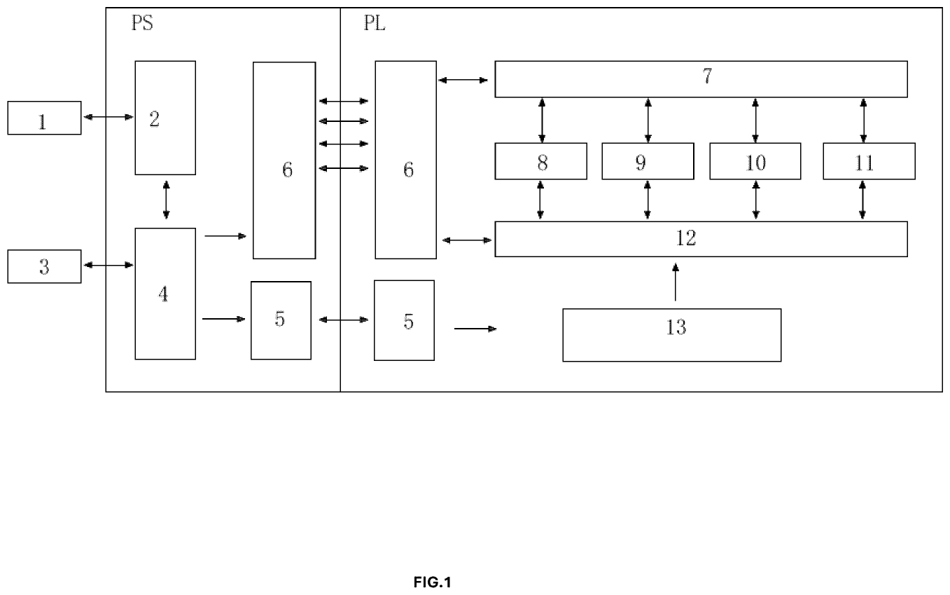

Embodiment 1 of the present disclosure provides a field-programmable gate array (FPGA)-based acceleration architecture for a convolutional neural network. As shown in FIG. 1, the FPGA-based acceleration architecture includes a processor system (PS), a programmable logic (PL), and an interface module. The PS is configured to: read data from an external storage device, store the data in a memory, and perform data exchange with the PL through the interface module. The PS is configured to: manage data transfer, and coordinate an execution sequence and task scheduling of modules based on control instructions, ensuring efficient and coordinated work of the entire system in an operation process.

A convolutional module, a pooling module, and an upsampling module are designed in the PL, and are configured to execute a key computational task in the convolutional neural network. The convolutional module is configured to extract a feature through hardware optimization, and a hardware structure of the convolutional module is integrated with a convolutional layer and a batch normalization layer, reducing storage and transfer of an intermediate computational result. In addition, an optimized algorithm is adopted in the module to reduce computational complexity, and improve throughput of a convolutional operation. The pooling module is configured to perform a pooling operation, and the upsampling module is configured to perform an upsampling operation.

The interface module is a core part for data transfer between the PS and the PL in the architecture, and can be configured to support batch transfer of data blocks. A latency optimization design is adopted in the module to enhance data transfer efficiency, thereby avoiding idle resources between the processor system and the programmable logic. Logical ports of the different modules in the PL are separately bound to independent buses, to support both parallel interaction and independent operation among the different modules in the PL. In addition, the interface module is designed to make data exchange between the PS and the PL be smoother, achieving coordinated computation at a hardware layer.

Through the aforementioned design, the hardware acceleration architecture in this embodiment not only meets the high computational demands of the convolutional neural network but also significantly enhances data exchange efficiency and system integration, and therefore, is applicable to an efficient acceleration task of a deep learning model.

### Embodiment 2

Based on Embodiment 1, this embodiment further describes the FPGA-based acceleration architecture for a convolutional neural network, with a focus on an optimized design of the interface module and an efficient computation method of the convolutional module, and describes functions and advantages in conjunction with specific application scenarios.

As shown in FIG. 1, the PS is configured to: read data from a secure digital (SD) card, and store the data into a double data rate (DDR) memory. The data stored in the DDR is transferred to the PL through an AXI interface for efficient execution of convolution and pooling computation of deep learning.

In interface design, the interface module in this embodiment includes an AXI-Lite interface and an AXI-Full interface. The AXI-Lite interface is mainly configured to transfer a control signal, ensuring simple and reliable instruction interaction between the PS and the PL. Signal congestion caused by high-volume data stream is avoided through a separate design of the control signal. The AXI-Full interface is configured to implement high-efficiency transfer of large-scale data, including exchange of core data such as feature map data, weight data, and a computation result. Through this interface, high-bandwidth data stream transfer can be achieved through the system, and hardware resources can be sufficiently utilized to enhance overall computational performance.

In a high-level synthesis (HLS) design process, a #pragma HLS INTERFACE instruction is configured to: define an interface type of input and output interfaces of the module, and optimize attributes. How a module interacts with an external system or another module, and directly affects performance and resource utilization of the interface can be clearly defined in this design process. Interface optimization is especially critical during massive read/write operations on the DDR memory. Due to an inherent latency of DDR access, a performance bottleneck is inevitable if every operation in the HLS design process needs to wait for completion of the DDR access. To optimize the resource utilization, an expected AXI interface latency is set in this embodiment, to optimize task scheduling. A bus request is allowed to be preemptively initiated by the interface module before read/write operations are executed on data, and other instructions are executed during request processing, thereby reducing processor idle time. Another task can be executed by using a latency optimization strategy during a DDR response wait period, effectively hiding a DDR access latency. This helps construct a more efficient pipeline, thereby enhancing an overall system throughput. This design not only improves utilization of bus resources, but also reduces waiting time of a computational task.

A port-binding optimization strategy is adopted by the interface module to support parallel interaction and independent operation of modules in the PL. Logical ports of functional modules in the PL are independently bound to a dedicated AXI bus, making each module independently execute a data transfer task, to avoid competition among the different modules. The convolutional module and the pooling module in the PL are used as an example. Each module is required to read different feature map data and weight data from the DDR memory. Logical ports of the convolutional module and the pooling module are respectively bound to two independent AXI buses, to read data in parallel without interference, making the pooling module prefetch a next batch of data while the current data is processed by the convolutional module. This improves overall pipeline efficiency. Through this design, when a task is simultaneously executed by the convolutional module, the pooling module, and the upsampling module, a data stream can be coordinated and allocated by the interface module, making it possible to perform parallel computation through the modules. This remarkably enhances data exchange efficiency. In addition, a bus binding mode is further provided by the interface module when resources are limited, to bind logical ports to a single physical AXI interface, achieving dynamic allocation of interface resources. For example, different computational units of the convolutional module, for example, a Winograd accelerator and a common convolution kernel, are separately configured to access the DDR memory through different logical ports. These logical ports are bound to a same AXI interface, and occupation of hardware interface resources is reduced by sharing physical interfaces. This flexible design is adaptable to performance needs in different application scenarios, improving utilization of interface resources.

In a contiguous address access scenario, the interface module in this embodiment supports a burst transfer mode. During the transfer of feature map data and weight data, a frequency of memory accesses is reduced and bus communication overheads are lowered by configuring a maximum burst length. For example, when a high-resolution image is processed, transfer of a whole block of data can be efficiently completed in the burst transfer mode, avoiding latency and power consumption problems associated with byte-by-byte transfer in the conventional mode.

Through the optimization measures on the interface module, the system performance during frequent DDR accesses can be significantly improved, reducing latency, increasing throughput, and utilizing the available bandwidth more efficiently. This is particularly important for data-intensive applications.

For the convolutional module, in this embodiment, the convolutional layer and the batch normalization (BN) layer are integrated into the single convolutional computational unit, to optimize computational efficiency. Specifically, scale and bias parameters of batch normalization are integrated based on a convolutional weight (W) and a bias parameter (b), and computation logics of the scale and bias parameters are integrated into an operation. The convolutional weight and the bias parameter are updated in the following steps, eliminating an additional step for separately executing a batch normalization operation.

A parameter of the convolutional layer is obtained, where the parameter includes a convolutional weight W and a convolutional bias b of the convolutional layer.

A parameter of the BN layer is obtained, where the parameter includes a scaling parameter γ, a bias parameter β, a mean μ, and a variance σ2.

The scaling parameter γ and the variance σ² of the BN layer are applied to the convolutional weight W, and a fused convolutional weight W′ is obtained by using the following formula:

$${W}^{′} = \frac{γ}{\sqrt{{σ}^{2} + ε}} \times W .$$

A new bias b′ is obtained by substituting the bias parameter β, and the mean μ of the BN layer, and the conventional bias b into the following formula:

$${b}^{′} = \frac{γ}{\sqrt{{σ}^{2} + ε}} \times ( b - μ ) + β ,$$

where
ε is a constant, and is used to prevent a zero denominator. In the optimization strategy, not only is computational complexity reduced, but also intermediate data storage resources are omitted, thereby making the convolutional operation more efficient.

In addition, convolutional computation is transformed, based on the Winograd convolution algorithm, into a matrix multiplication format by the convolutional module, thereby reducing a quantity of multiplication operations. For example, 9 multiplications are required through traditional 3×3 convolution, and can be reduced to 4 multiplications by using the Winograd algorithm. This improvement is particularly remarkable in multi-layer deep networks or when high-resolution images are processed, and therefore computational energy consumption is effectively reduced and processing time is shortened.

Through the optimized design in this embodiment, a synergistic collaboration between the interface module and the convolutional module is formed, enabling the FPGA-based acceleration system for a convolutional neural network to have outstanding performance in computation-intensive tasks. Furthermore, the system provides flexible resource allocation capabilities, adapting to various practical scenarios and providing comprehensive support for accelerating training of the convolutional neural network.

The above described are preferred implementations of the present disclosure, and it should be noted that for those of ordinary skill in the art, various improvements and modifications may be made without departing from the principles of the present disclosure. These improvements and modifications should be regarded as falling within the protection scope of the present disclosure.

What is claimed is:

1. A field-programmable gate array (FPGA)-based acceleration architecture for a convolutional neural network, comprising:
a processor system (PS), configured to: read data from an external storage device, store the data in a memory, and perform data exchange with a programmable logic (PL) through an interface module, wherein a computational process is controlled and coordinated by the PS, and feature map data, weight data, and a computation result are transferred between the PS and the PL through the interface module;
the PL comprising a convolutional module, a pooling module, and an upsampling module, wherein the PL is configured to: receive the data stored in the memory from the PS through the interface module, and perform parallel computation, wherein
the convolutional module is configured to: extract an image feature, and reduce computational complexity by integrating a convolutional layer and a batch normalization layer into a single convolutional computational unit and adopting a Winograd convolution algorithm for optimization;
the pooling module is configured to perform a pooling operation; and
the upsampling module is configured to perform an upsampling operation; and
the interface module configured to connect the PS and the PL, to support data transfer and control and enable control instructions from the PS to be executed in coordination with the parallel computation on the PL; and separately bind logical ports of different modules in the PL to independent buses by using a latency optimization mechanism, to support both parallel interaction and independent operation among the different modules in the PL.

2. The FPGA-based acceleration architecture for a convolutional neural network according to claim 1, wherein the interface module comprises an AXI-Lite interface and an AXI-Full interface, the AXI-Lite interface is configured to transfer a control signal between the PS and the PL, and the AXI-Full interface is configured to transfer the feature map data, the weight data, and the computation result between the PS and the PL, to separate the control signal from a data stream.

3. The FPGA-based acceleration architecture for a convolutional neural network according to claim 2, wherein the interface module is configured with an expected AXI interface latency, to allow a bus request to be initiated before a read/write operation is executed.

4. The FPGA-based acceleration architecture for a convolutional neural network according to claim 2, wherein the interface module is configured to separately bind logical ports of the different modules in the PL to independent AXI buses in a port binding manner, to support parallel data transfer of the different modules.

5. The FPGA-based acceleration architecture for a convolutional neural network according to claim 4, wherein the interface module is configured to bind the logical ports of the different modules in the PL to a same physical AXI in a bus binding manner.

6. The FPGA-based acceleration architecture for a convolutional neural network according to claim 1, wherein continuous access to data at contiguous addresses is supported by the interface module, and when a port read operation is executed, the feature map data and the weight data are transferred in a burst transfer mode, and a maximum burst length is set.

7. The FPGA-based acceleration architecture for a convolutional neural network according to claim 1, wherein the integrating a convolutional layer and a batch normalization (BN) layer into a single convolutional computational unit comprises:
obtaining a parameter of the convolutional layer, wherein the parameter comprises a convolutional weight W and a convolutional bias b of the convolutional layer;
obtaining a parameter of the BN layer, wherein the parameter comprises a scaling parameter γ, a bias parameter β, a mean μ, and a variance σ²;
applying the scaling parameter γ and the variance σ² of the BN layer to the convolutional weight W, and obtaining a fused convolutional weight W′ by using the following formula:
$${W}^{′} = \frac{γ}{\sqrt{{σ}^{2} + ε}} \times W ;$$
obtaining a new bias b′ by substituting the bias parameter β and the mean μ of the BN layer, and the conventional bias b into the the following formula:
$${b}^{′} = \frac{γ}{\sqrt{{σ}^{2} + ε}} \times ( b - μ ) + β ,$$
wherein
ε is a constant, and is used to prevent a zero denominator; and
updating the parameter of the convolutional layer to W′ and b′.

8. The FPGA-based acceleration architecture for a convolutional neural network according to claim 1, wherein the convolutional module is configured to reduce, based on the Winograd convolution algorithm, a quantity of multiplication operations required for a convolutional operation by transforming convolutional computation into a matrix multiplication.
